(19) United States
(12) Patent Application Publication
(10) Pub. No.: US 2024/0270417 A1
(43) Pub. Date: Aug. 15, 2024

(54) METHOD FOR MANUFACTURING A PACKING CONTAINER HAVING AN INLAY, INSERTION DEVICE, AND PACKAGING MACHINE

(71) Applicant: HDG-Verpackungsmaschinen GmbH, Lindlar (DE)

(72) Inventor: Martin GRESSLER, Bergisch Gladbach (DE)

(21) Appl. No.: 18/568,187

(22) PCT Filed: Jun. 7, 2022
(86) PCT No.: PCT/EP22/65335

§ 371 Date: Dec. 7, 2023

(30) Foreign Application Priority Data
Jun. 8, 2021 (DE) 10 2021 205 795.0

(51) Int. Cl. B65B 1/02; B65B 3/02; B65B 7/16; B65B 43/00

(52) U.S. Cl. CPC B65B 1/02; B65B 3/02; B65B 7/16; B65B 43/00

(57) ABSTRACT

The present invention relates to a method for manufacturing a packaging container having an inlay, said method comprising the steps of: arranging a first layer of packaging material and a second layer of packaging material to form a packaging container; positioning an inlay between the first and second layers of packaging material; joining at least a first region of the inlay to the first layer of packaging material; manufacturing a packaging container by joining the first and second layers of packaging material such that a filling opening of the packaging container is formed between the second region of the inlay and the second layer of packaging material; and joining at least a second region of the inlay to the second layer of packaging material of the filled packaging container. The invention also relates to an insertion device and to a packaging machine.

The invention relates to a method for manufacturing a packaging container with inlay, an insertion device for inserting an inlay between layers of packaging material, and a packaging machine for manufacturing a packaging container with inlay.

Flexible packaging containers made of film, for example fiber, in particular pulp, wood pulp and/or paper, in particular waste paper pulp, and/or plastic such as polypropylene (PP), polyethylene (PE), polystyrene (PS), polyethylene terephthalate (PET), have the advantage of low weight compared to cans, glass containers or similar containers. They have a positive impact on CO2 emissions, in particular in manufacturing and logistics. Emptying of the container can be a disadvantage in certain applications. If it is opened, dosing of in particular powder and/or granules and/or free-flowing products is uncontrolled.

Inserts, such as a membrane, a valve and/or a spout, also called inlays, which can be inserted into a flexible packaging container, enable controlled emptying and/or dosing of the packaging contents. An exemplary membrane is described in EP/2015/0798195. However, the manufacture of a packaging container with an inlay is complex and time-consuming. Filling of the packaging containers manufactured is also often challenging.

It is therefore an object of the present invention to provide an improved method for manufacturing a packaging container with inlay, an improved insertion device for inserting an inlay between layers of packaging material, and an improved packaging machine for manufacturing a packaging container with inlay.

This object is solved by the subject matters of the independent claims. Advantageous embodiments are the subject of the subclaims.

One aspect of the invention relates to a method for manufacturing a packaging container with inlay, comprising the steps of:
arranging a first layer of packaging material and a second layer of packaging material to form a packaging container;
positioning an inlay between the first and second layers of packaging material;
connecting at least a first region of the inlay to the first layer of packaging material;
manufacturing a packaging container by connecting the first and second layers of packaging material such that a filling opening of the packaging container is formed between the second region of the inlay and the second layer of packaging material;
connecting at least a second region of the inlay to the second layer of packaging material of the filled packaging container.

Manufacturing a packaging container within the meaning of the present application describes in particular manufacturing a preferably hollow, thin-walled article suitable for accommodating one or more other articles, wherein a packaging container manufactured has at least one dispensing opening, which is formed by the inlay, through which filling material can be dispensed and/or emptied and/or removed and/or taken out from the packaging container.

In the present application, reference is made in particular to packaging containers suitable for accommodating filling material in the form of bulk materials. For example, bulk materials is understood to mean substantially powdery, grainy, granular and/or lumpy mixtures, which are preferably in pourable form, such as coffee, rice, sugar, salt, spices, baking powder, herbs, glitter and the like. Furthermore, the packaging container can be suitable for accommodating liquids and/or substantially pourable mixtures and for dispensing them through the inlay.

The use of an inlay in the container in particular enables targeted and/or repeatable dosing.

Advantageously
the inlay has one or more dispensing openings,
the inlay is configured to enable dosing and/or controlled dispensing of the contents of the packaging container; and/or
the inlay comprises a valve and/or a membrane and/or a grid and/or a braiding and/or a spout; and/or
the inlay comprises a first element, which is substantially elastically deformable and resilient, and a second element, which is substantially elastically deformable and/or stretchable and/or foldable and has one or more dispensing openings.

In particular, an inlay can be similar to or correspond to the membrane described in EP/2015/0798195. For exemplary properties and/or features of such a membrane, reference is explicitly made to EP/2015/0798195.

Preferably, the method further comprises closing the filled packaging container by connecting the first and second layers of packaging material. The layers of packaging material are preferably connected in a region between the inlay and an edge region of the packaging container. In this way, the contents of the packaging container are protected from atmospheric influences such as moisture, for example, in order to ensure a longer shelf life.

Advantageously, the first layer of packaging material is arranged substantially opposite and/or overlapping the second layer of packaging material; and/or
the first region of the inlay is arranged substantially opposite the second region of the inlay; and/or
the filling opening of the packaging container is temporarily formed and closed by connecting the second region of the inlay to the second layer of packaging material; and/or
after connecting the second region of the inlay to the second layer of packaging material, a dispensing opening for dispensing packaging container contents is formed only by the inlay. In other words, the packaging container is closed on all sides, wherein the closure is formed by the inlay on one side and the layers of packaging material are connected to one another on the remaining sides. Preferably, the layers of packaging material are materially/firmly connected to one another or the two layers of packaging material are provided by bending a layer of packaging material on one side.

Preferably, upon connection the first region of the inlay to the first layer of packaging material, substantially no connection of the inlay to the second layer of packaging material takes place. This can be achieved in particular by bringing two opposite sealing jaws into engagement with the inlay and the layers of packaging material, with preferably only the sealing jaw of the first layer of packaging material being heated, so that a connection takes place between the first layer of packaging material and the inlay. The sealing jaw of the second layer of packaging material is preferably not heated and/or cooled, so that no connection between the second layer of packaging material and the inlay takes place. Optionally, an adhesive and/or a sealing wax can be present in the area between the inlay and the packaging material, which enables improved connection. It is also possible that, upon connection of the first layer of packaging material to the inlay, a spacer element is inserted between the second layer of packaging material and the inlay, which prevents the inlay and the second layer of packaging material from contacting each other and/or which prevents the second layer of packaging material from being heated. Alternatively or in addition, a spacer element can be arranged within the inlay, so that only the side of the inlay assigned to the first layer of packaging material is heated. It is also possible to enable a material connection between the first layer of packaging material and the inlay by means of a cold adhesive that is only applied between the first layer of packaging material and the inlay.

Advantageously, the method further comprises deforming the packaging container such that the filling opening of the packaging container is opened; and filling the packaging container with filling material through the filling opening of the packaging container.

The filling opening of the packaging container is achieved by connecting only one side of the inlay to the layer of packaging material adjoining it, with a second side of the inlay not being connected to the layer of packaging material adjoining it. This filling opening is designed to be temporary and is closed after filling of the packaging container by connecting the second side of the inlay to the layer of packaging material adjoining it. This means that there is now only one dispensing opening, which is formed by the inlay.

To fill the packaging container, the inlay is preferably deformed such that it releases the temporary filling opening, so that filling material can be easily introduced into the packaging container through this temporary filling opening, i.e. between one side of the inlay and an opposite side of the second layer of packaging material. After filling, the deformation of the inlay is canceled so that the temporary filling opening is substantially covered, i.e. closed. The temporary filling opening is then closed. Advantageously, the inlay is elastically deformable so that it returns to its original position or configuration after the packaging container has been filled. The temporary filling opening can be closed by connecting the second layer of packaging material to the inlay, particularly preferably in a materially/firmly connected manner. The connection, in particular the material-to-material connection, can be created by fusing the inlay with the second layer of packaging material and/or fusing a hot melt adhesive of the inlay with the second layer of packaging material and/or the inlay.

Further preferably, the method further comprises:
supplying a plurality of interconnected inlays for example by unwinding interconnected inlays from a reel; and/or
gripping and/or holding an inlay; and/or
separating the gripped and/or held inlay; and/or
positioning the separated inlay between the first and second layers of packaging material.

For an efficient and substantially continuous manufacture of packaging containers, it is advantageous to supply and/or provide the inlays on a “reel”, i.e. a spool or roll, for example lined up and/or connected to one another. Alternatively, the inlays can be provided in a battery and/or a stack. In order to bring an inlay into contact with the packaging material, it is advantageous to grip an inlay, if necessary to separate this inlay from a “reel” and to position the inlay between the first and second layers of packaging material such that at least one region of the inlay can be connected to at least one layer of packaging material.

Advantageously, positioning the inlay between the first and second layers takes place by:
a substantially rotational displacement of the inlay, preferably about an axis of rotation aligned orthogonally to a direction of transport of the first and second layers of packaging material; and/or
a substantially translational displacement of the inlay, preferably at least partially parallel and/orthogonal to a direction of transport of the first and second layers of packaging material; and/or
a displacement of the inlay such that the inlay is positioned and/or aligned substantially congruently and/or parallel to a direction of transport of the first and second layers of packaging material.

The positioning described is particularly advantageous since the inlay is inserted such that it is displaced substantially identically to the packaging material. This results in an advantageous insertion of the inlay, which substantially does not hinder and/or negatively influence the manufacturing process of the packaging container. In particular, such an insertion is suitable for being integrated substantially seamlessly into existing HFFS processes, both in a substantially continuous and in an intermittent process.

A further aspect of the invention relates to an insertion device for inserting and/or positioning an inlay between a first and a second layer of packaging material, the insertion device being configured
to accommodate an inlay at least temporarily;
to position between a first and a second layer of packaging material; and
to release the inlay again.

The insertion device is particularly suitable for being integrated into a packaging machine and for inserting an inlay into the manufacturing process of a packaging container.

Preferably, the insertion device further comprises:
a gripping device for gripping and/or holding an inlay; and
a separating device for separating the gripped and/or held inlay from the plurality of interconnected inlays; and
a positioning device for positioning the separated inlay between the first and second layers of packaging material.

An exemplary gripping device comprises a first element and a second element, wherein at least one of these elements is displaceable so that an inlay can be clamped between the first and second elements. A separating device capable of separating and/or severing an inlay from a chain and/or a group of inlays is preferably provided. The positioning device is preferably configured to displace the gripping device and the gripped and/or held inlay in order to supply the inlay to the manufacturing process of the packaging container.

Advantageously, the positioning device is configured to:
displace the inlay substantially rotationally, preferably about an axis of rotation aligned orthogonally to a direction of transport of the first and second layers of packaging material; and/or
displace the inlay substantially translationally, preferably at least partially parallel and/or congruent to a direction of transport of the first and second layers of packaging material; and/or
displace the inlay such that the inlay is positioned and/or aligned substantially congruently and/or parallel to a direction of transport of the first and second layers of packaging material.

Particularly preferably, the inlay is displaced such that it is supplied to the packaging material such that it has a displacement that is substantially identical to that of the packaging material. As a result, the inlay is advantageously supplied to the packaging material, so that the manufacturing process of the packaging container is substantially not negatively influenced and/or the course of the manufacturing process is not negatively influenced.

A further aspect of the invention relates to a packaging machine for manufacturing a packaging container with inlay, comprising:
an arranging device for arranging a first layer of packaging material and a second layer of packaging material to form a packaging container;
an insertion device according to an aspect of the invention;
a connecting device for connecting a first region of the inlay to the first layer of packaging material; and
a closing device for connecting a second region of the inlay to the second layer of packaging material.

The above-mentioned packaging machine has a device that is configured to connect a packaging material that is transported at a substantially constant speed. This has the particular advantage that no intermittent transport, i.e. alternating acceleration and braking or stopping, of the packaging material is required. In this way, in particular the manufacturing process can be accelerated. Alternatively and/or in addition, a force—caused by repeated acceleration and braking—acting on the packaging material can be avoided, so that material fatigue is prevented or at least reduced, and less resistant packaging materials can therefore be used as well.

The connecting device is advantageously configured to connect only the first region of the inlay to the first layer of packaging material. Preferably, the closing device is configured to connect only the second region of the inlay to the second layer of packaging material and, preferably, to close the packaging container by connecting the first and second layers of the packaging material.

This allows a temporary filling opening to be formed in the packaging container, which is closed after filling, for example by connecting the second side of the inlay to the layer of packaging material abutting thereon using the closing device. The packaging container then only has one dispensing opening, which is formed by the inlay.

In particular, the connecting device and/or the closing device is configured to connect the inlay to the packaging material, in particular by means of firm/material-to-material connection. Such a connecting device and/or closing device comprises, for example, two elements that are pressed against one another under pressure in order to firmly/materially connect two or more layers of packaging material located between the elements and/or a layer of packaging material and the inlay. For example, an at least partial or complete material-to-material connection can be provided by means of cold glue, hot gelt, two-component (2K) adhesive, hot melt adhesive, dispersion adhesive, contact adhesive, polymerization adhesive, pressure sensitive adhesive and/or by melting a solid adhesive component and/or by means of multi-component adhesive and/or by means of another conventional adhesive method. Preferably, means are provided to push and/or press the components to be connected against one another and/or to heat them in order to possibly melt, i.e. at least soften or liquefy, one or more adhesive components.

Particularly preferably, the connecting device has two sealing jaws, which are displaceably arranged and between which the layers of packaging material and the inlay can be arranged. By bringing the sealing jaws together, pressure can be exerted at least in some areas on the packaging material and/or the inlay. Preferably, only the sealing jaw that is in contact with the first layer of packaging material is heated, so that a connection takes place only between the inlay and the first layer of packaging material. The other sealing jaw is preferably unheated and/or cooled, so that there is no connection between the inlay and the second layer of packaging material. In this way, a filling opening can be created between the inlay and the second layer of packaging material, through which filling material can be introduced into the packaging container. After filling, the filling opening is closed by connecting the inlay to the second layer of packaging material, for example by a heated sealing jaw, which comes into contact with the second layer of packaging material.

Advantageously,
the inlay has one or more dispensing openings,
the inlay is configured to enable dosing and/or controlled dispensing of the contents of the packaging container; and/or
the inlay comprises a valve and/or a membrane and/or a grid and/or a braiding and/or a spout; and/or
the inlay comprises a first element, which is substantially elastically deformable and resilient, and a second element, which is substantially elastically deformable and/or stretchable and/or foldable and has one or more dispensing openings.

Depending on the packaging container to be manufactured, the inlay can have advantageous features and/or dimensions. For example, a plurality of small dispensing openings can be advantageous for fine powder filling material, whereas a smaller number of larger dispensing openings can be advantageous for coarse powder filling material. The same applies to features of a grid and/or a braiding and/or a spout.

Preferably, the packaging machine further comprises:
a supply device for supplying a plurality of interconnected inlays to the insertion device; and/or
a detection device for detecting the presence and/or the type and/or the alignment of an inlay supplied to the insertion device.

With such an advantageous supply device, a large number of inlays can be reliably supplied to the insertion device, for example from a cassette and/or “reel”.

In the following, individual embodiments for solving the object will be described using the figures. Here, some of the individual embodiments described have features that are not absolutely necessary to carry out the claimed subject matter, but which provide desired properties in certain applications. Embodiments that do not include all the features of the embodiments described below shall also be considered as being comprised by the technical teaching described. Furthermore, in order to avoid unnecessary repetition, certain features are only mentioned in relation to individual embodiments described below. It should be noted that the individual embodiments should therefore not only be viewed individually, but also in conjunction. Based on this overview, the skilled person will recognize that individual embodiments can also be modified by incorporating individual or multiple features of other embodiments. It is pointed out that a systematic combination of the individual embodiments with one or more features described in relation to other embodiments may be desirable and useful and shall therefore be considered to be comprised by the description.

### BRIEF DESCRIPTION OF THE DRAWINGS

FIG. 1 shows an exemplary packaging machine for manufacturing a packaging container with inlay;

FIG. 2 shows an exemplary embodiment of an insertion device and a supply device for a packaging machine;

FIG. 3 shows an exemplary embodiment of an insertion device for inserting an inlay for manufacturing a packaging container with inlay;

FIG. 4 shows a second illustration of the insertion device of FIG. 3;

FIG. 5 shows a diagram of the operation of an exemplary insertion device;

FIG. 6 shows exemplary embodiments of a gripping device and a positioning device of an insertion device;

FIG. 7 shows an exemplary packaging machine for manufacturing a packaging container with inlay with the exemplary insertion device and the exemplary supply device of FIG. 2.

### DETAILED DESCRIPTION OF THE DRAWINGS

Two types of packaging machines are particularly common in the packaging industry: horizontal form fill and seal machine (HFFS) and vertical form fill and seal machine (VFFS). These packaging machines or packaging methods differ in particular with regard to a substantial direction of transport of the packaging material or packaging containers. In an HFFS process, the packaging material and/or packaging containers are transported substantially in a horizontal direction. In a VFFS process, the packaging material and/or the packaging containers are transported substantially in a vertical direction. The packaging machine, insertion device and method according to aspects of the present invention are particularly suitable for HFFS applications.

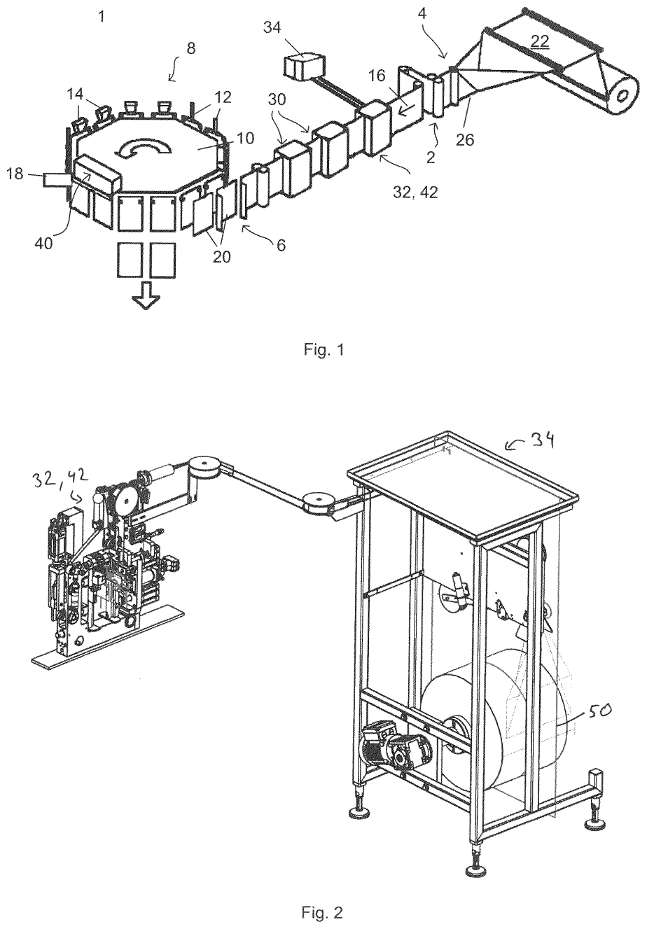

FIG. 1 shows an exemplary packaging machine for manufacturing a packaging container with inlay. The packaging machine 1 shown has an HFFS configuration. The packaging machine 1 comprises a reel of packaging material 22 for manufacturing packaging containers 20. The packaging material 22 is supplied to the packaging machine 1 by an arranging device 2 in a substantially horizontal direction of transport 16. In the embodiment shown, the arranging device 2 comprises a pair of driven rollers or cylinders that transport or convey the packaging material 22. As shown in FIG. 1, the packaging machine 1 further has a forming or folding device 4 for (re)forming and/or folding the packaging material 22. In the example shown, the forming or folding device 4 is configured to fold the packaging material 22 substantially in the middle to form a double band (comprising two layers) of the packaging material 22 with a fold or pleat 26 along one side. In other words, folding the packaging material 22 provides a first layer of packaging material and a second layer of packaging material. In the exemplary embodiment shown, the arranging device 2 is arranged downstream of the forming or folding device 4. Alternatively and/or in addition, the arranging device 2 can be arranged upstream of the forming or folding device 4. Furthermore, the packaging machine 1 can have one or more additional arranging devices 2 and/or forming or folding devices 4, wherein they can be arranged at different locations in the packaging machine 1.

As an alternative to the example shown, the packaging material 22 can be stored in the form of individual pieces or sheets. In such an example, the arranging devices 2 and/or the forming or folding device 4 are preferably designed such that two or more, in particular three or four, pieces or sheets of the packaging material 22 are arranged and/or transported at least partially overlapping or lying one on top of the other.

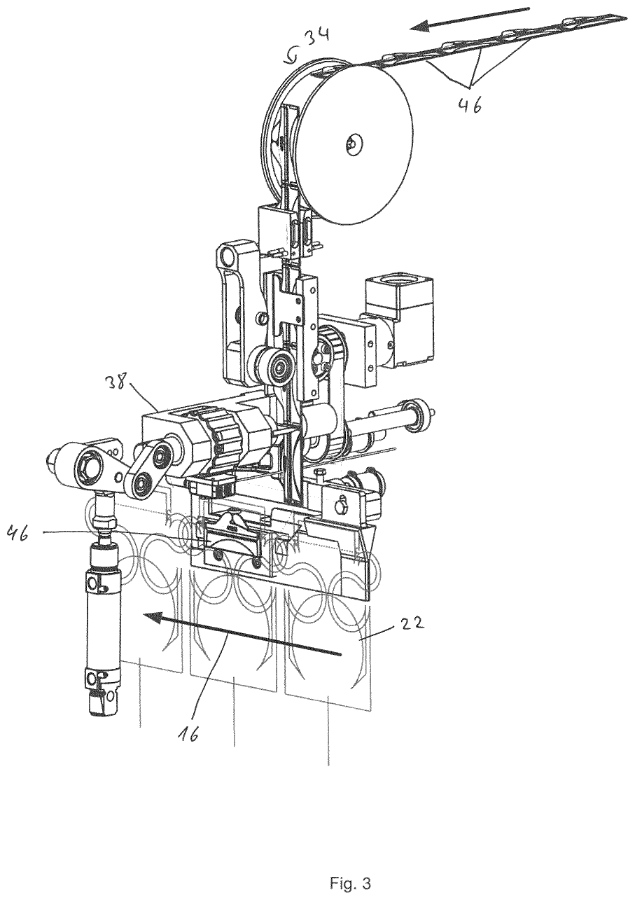

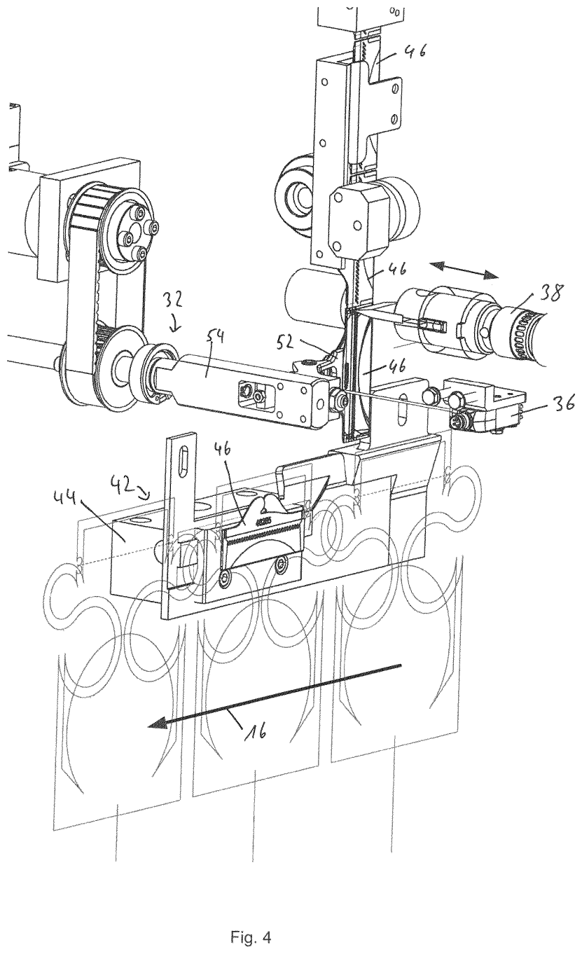

The exemplary packaging machine 1 further comprises an insertion device 32 for inserting an inlay 46 between layers of packaging material 22. An exemplary insertion device 32 is shown e.g. in FIGS. 4 and 6. Moreover, the packaging machine 1 shown comprises a supply device 34 for supplying inlays 46 to the insertion device 32. An exemplary supply device is shown in FIGS. 2 and 3. Preferably, the inlay 46 is connected to only one layer of the packaging material 22 and is transported further together with the packaging material 22. To this end, the packaging machine 1 comprises a connecting device 42 for connecting preferably a layer of packaging material 22 to the inlay 46. An exemplary connecting device 42 is shown in FIGS. 3 and 4. By only partially connecting the inlay 46 to the packaging material 22, a temporary filling opening is formed, which is formed between the inlay 46 and the layer of packaging material 22 that is not connected to the inlay 46.

The packaging machine 1 shown in FIG. 1 further comprises one or more, for example two, container forming devices 30 for connecting two or more, in particular three or four, layers of packaging material 22. Preferably at least one of the container forming devices 30 is configured to create at least one, in particular two or three, connecting seams 24 in or on at least part of the packaging material 22.

Particularly preferably, the container forming devices 30 are configured to create connecting seams 24 between and/or overlapping with the inlays 46. The connecting seams 24 preferably separate the inlays 46 from each other. More preferably, the connecting seams 24 are substantially flush and/or overlapping with the inlay, so that no filling material in the packaging container 20 can escape between the inlay 46 and the connecting seam 24.

The one or more container forming devices 30 are preferably arranged in the direction of transport 16 of the packaging material 22 downstream of the insertion device 32 and the connecting device 42. Alternatively and/or in addition, at least one container forming device 30 can be arranged upstream of the insertion device 32 and the connecting device 42. A container forming device 30 can in particular be configured to create a connecting seam 24 substantially orthogonal or transverse to the direction of transport 16 of the packaging material 22. Alternatively and/or in addition, a connecting device can be configured to create a connecting seam 24 substantially parallel or longitudinal to the direction of transport 16 of the packaging material 22.

In the exemplary packaging machine 1 shown in FIG. 1, the two container forming devices 30 are configured to manufacture packaging containers 20 by creating a respective connecting seam 24 orthogonal or perpendicular to the direction of transport 16 and/or the formed fold 26 of the packaging material 22. In the packaging machine 1 shown, a plurality of packaging containers 20 are manufactured on the belt of packaging material 22 in this way. Each packaging container 20 is preferably formed by two adjacent or neighboring connecting seams 24 and the portion of packaging material 22 located between them, this portion comprising the inlay 46. The packaging containers 20 further have a temporary filling opening on the side opposite the fold 26, the temporary filling opening being formed by the inlay 46 and the layer of packaging material 22 that is not connected to the inlay 46.

The packaging machine 1 of FIG. 1 comprises one or more, for example two, separating devices 6 for separating or severing or isolating one or more packaging containers 20 from the belt of packaging material 22. In the example shown, the separating device 6 comprises two separating tools, for example a knife or a blade or cutting edge, which are configured to cut or sever at least part of the packaging material 22. In the exemplary embodiment of the packaging machine 1 shown, the separating device 6 is configured to separate a region of the packaging material 22 that forms a packaging container 20.

According to an alternative embodiment, a packaging machine 1 can have a plurality, for example two, separating devices 6, which are preferably not arranged directly adjacent to one another in the packaging machine. For example, a first separating device 6 can separate the packaging material 20 such that the separated portion has two or more contiguous packaging containers 20. The separated portion can be transported to devices for filling and/or closing and, optionally, subsequently supplied to a second separating device 6, which separates at least one packaging container 20 from the previously separated portion. A separating device 6 can alternatively and/or in addition be arranged upstream of a forming or folding device 4.

In the present exemplary embodiment, the packaging machine 1 comprises a rotary machine 10 for picking up and/or transporting or conveying one or more packaging containers 20 and/or individual portions of the packaging material 22. The rotary machine 10 is preferably configured to supply one or more packaging containers 20 and/or or separated portions of the packaging material 22 substantially continuously or intermittently to one or more stations or devices of the packaging machine 1, in particular to a filling device 8 of the packaging machine 1 for filling the packaging containers 20 with filling material, preferably with bulk material. Advantageously, the filling device 8 has an opening device and/or pocket forming device 12 for opening the filling opening of the packaging container 20 and/or forming the packaging container 20, in particular by forming a substantially bulbous pocket—in preparation for filling the packaging container 20.

Particularly preferably, the opening device and/or pocket forming device 12 is designed to deform the packaging container 20 and the inlay 46 such that the temporary filling opening is released and/or (further) opened.

One or more, for example two, three or four, introduction devices 14 are configured to fill the packaging containers 20 with filling material, in particular with bulk material, through the temporary filling opening.

As shown in FIG. 1, the rotary machine 10 is preferably configured to transport or convey the packaging containers 20 along a substantially circular path to one or more stations or devices of the packaging machine 1, in particular the filling device 8. Preferably, the packaging containers 20 can temporarily remain substantially stationary at one or more of the devices.

The packaging machine 1 further has one or more, in particular 2 or 3, closing devices 40. The closing device 40 is in particular configured to close the temporary filling opening by connecting the packaging material 22 and the region and/or the side of the inlay 46 that has not already been connected to the packaging material 22 by the connecting device 42. After closing the temporary filling opening, the packaging container 20 only comprises one or more dispensing openings through the inlay 46.

The closing device 40 is preferably further configured to close one or more, for example two, packaging containers 20. In the present example, two filled packaging containers 20 are supplied to a closing device 40 and closed by it. A closing device 40 is preferably configured to close the packaging material 22 in a region of the packaging container 20 that is separated from the filling material by the inlay 46.

Preferably, the closing device 40 comprises one or more sealing jaws 44 for creating at least one connecting seam 24 for closing the packaging container 20. The closing device 40 can be designed to be substantially stationary or displaceable relative to the one or more packaging containers. Alternatively and/or in addition, the closing device 40 can be configured to apply an adhesive to close the opening. It is particularly advantageous to close the opening using cold glue or a similar cold-bonding adhesive. The manufactured, filled and closed packaging container 20 with inlay 46 is then routed out of the packaging machine 1. Furthermore, the packaging machine 1 optionally has one or more control devices 18 for checking or inspecting in particular the packaging material 22 and/or a connecting seam 24. The transport or supply of the packaging material 22 and/or the packaging containers 20 can in particular be carried out substantially intermittently or continuously. In particular, the transport in the individual stations or sections of the packaging machine 1 can vary. As shown in the example of FIG. 1, the packaging material 22 is preferably transported or conveyed substantially continuously, i.e. at a substantially constant speed, in particular without acceleration, at least up to a separating device 6.

FIG. 2 shows an exemplary embodiment of an insertion device 32 and a supply device 34 for use in a packaging machine 1. The exemplary supply device 34 shown is configured to guide inlays 46 to the insertion device 32 and/or to supply them to the insertion device 32. The supply device 34 comprises a receptacle for arranging a cassette and/or a roll and/or a “reel”, from which interconnected inlays 46, for example in the form of a chain, are supplied to the insertion device 32. The supply device 34 preferably has one or more deflection rollers in order to provide the inlays 36 in an advantageous orientation and/or at a predetermined position, as well as one or more drive devices for conveying the inlays 46. A drive device can in particular include an electric drive and/or a pneumatic drive and/or a hydraulic drive. In this way, it is possible to advantageously provide the inlays 46 at the insertion device 32.

The exemplary insertion device 32 shown is in particular configured to receive an inlay 46 supplied by the supply device 34 and to supply it to the packaging material 22 such that it can be connected to the packaging material 22. This process is shown in particular in FIGS. 3 and 4 and will be described below.

FIG. 3 shows an exemplary embodiment of an insertion device 32 for inserting an inlay 46 for manufacturing a packaging container 20 with inlay 46.

The packaging material 22 is supplied to or arranged at the insertion device 32 in the direction of transport 16 shown.

The inlays 46 are supplied to the insertion device 32 via a deflection roller.

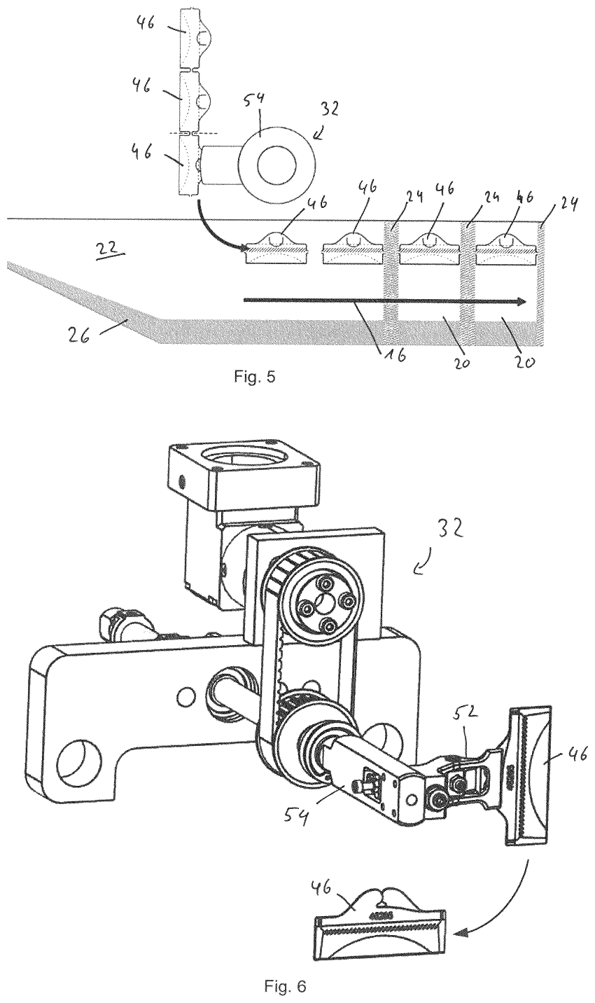

In the exemplary embodiment shown, the supplied inlays 46 have an orientation substantially perpendicular to an orientation in which the inlays 46 are to be connected to the packaging material 22. The insertion device 32 is configured to receive the separated inlay 46 and to displace it such that it is arranged between at least two opposite layers of packaging material 22. This process is shown in FIGS. 5 and 6.

Preferably, the insertion device 32 or the packaging machine 1 further comprises a separating device 38. Such a separating device 38 is particularly advantageous if the supplied and/or provided inlays 46 are connected to one another, so that an inlay 46 can be severed from the connected inlays 46. The separating device 38 can have a knife and/or a blade or cutting edge, for example, which can be displaced in order to separate a connection between two inlays 46 and to separate an inlay 46. The separation of an inlay 46 preferably takes place after the insertion device 32 has received the inlay 46 to be separated.

FIG. 4 shows a second view of the insertion device of FIG. 3. In particular, the displacement movement of a knife of the separating device 38 is shown, by which an inlay 46 is separated from the connected inlays 46.

What is also shown is a sealing jaw 44 of the connecting device 42, which can be brought into contact with a layer of the packaging material 22 in order to connect the layer of packaging material 22 to the inserted and/or positioned inlay 46. Advantageously, the sealing jaw 44 is heated in order to ensure an advantageous connection between one layer of packaging material 22 and the inlay 46. Alternatively and/or in addition, an adhesive, in particular glue and/or sealing wax, can be provided between the layer of packaging material 42 and the inlay 46 in order to create a connection.

The connecting device 42 is in particular designed such that only a first layer of the packaging material 22 is connected to one side and/or a region of the inlay 46, with the second, in particular opposite, layer of packaging material 22 not being connected to the inlay 46. This can be done, for example, by a second sealing jaw (not shown), which is pressed against the first sealing jaw 44 and presses the layers of packaging material 22 and the inlay 46 together, the second sealing jaw being, for example, not heated and/or cooled, so that no connection, in particular no material-to-material connection is created between the second layer of packaging material 22 and the inlay 46.

FIG. 4 further shows an optional detection unit 36, which comprises one or more sensors and is configured to detect the presence and/or the type and/or the location and/or the position of an inlay 46. For example, the supply device 34, the insertion device 42 and/or the separating device 38 can be controlled by a control unit in order to ensure proper separation and/or insertion of the inlay 46 and/or to stop the packaging machine 1.

FIG. 5 shows a diagram of the operation of an exemplary insertion device 32. The operation shown is particularly advantageous since the inlay 46 is displaced by a positioning device 54 of the insertion device 32 such that it has a displacement that substantially corresponds to the direction of transport 16 of the packaging material 22. In this way, the inlay 46 is supplied to the packaging material 22 without the manufacturing process of the packaging containers being negatively and/or undesirably influenced, in particular without having to be slowed down and/or interrupted.

As is also shown in FIG. 6, in the preferred embodiment shown, the inlay 46 is displaced rotating through 90° about an axis of rotation perpendicular to the direction of transport 16 of the packaging material 22. The displacement of the inlay 46 by the insertion device 32 can also be designed differently if the packaging material 22 and/or the supply of the inlays 46 are configured differently. For example, rotating through 180° can be advantageous and/or additionally rotating about an axis parallel to the direction of transport 16 of the packaging material 22.

FIG. 5 further shows connecting seams 24 that were created between the inlays 46 connected to a layer of packaging material 22. As described, creating the connecting seams 24 with the inlays 46 substantially flush and/or overlapping is advantageous in order to ensure that the region of the packaging container 20 that contains or will contain the filling material is sealed by the inlay 46.

FIG. 6 shows exemplary embodiments of a gripping device 52 and a positioning device 54 of an insertion device 32 with the mode of operation shown in FIG. 5.

The exemplary gripping device 52 is configured to grip and/or hold an inlay 46. To this end, a first gripping element displaces relative to a second gripping element such that the first gripping element is spaced from the second gripping element. This can be done, for example, by means of a drive, in particular an electric drive and/or a pneumatic drive and/or a hydraulic drive. The gripping device 52 is then displaced to an inlay 46 or an inlay 46 is positioned between the gripping elements of the gripping device 52. The gripping elements are guided toward one another and/or coupled to one another, so that the inlay 46 is clamped between the gripping elements and is held by them.

If the inlay 46 is connected to other inlays 46, the inlay 46 can now be separated and/or severed, for example by the separating device 38 shown in FIG. 4.

The gripping device 52 is coupled to a positioning device 54, which is configured to displace the gripping device 52 from the starting position shown. In the present example, the gripping device 52 and the held inlay 46 are rotated by 90°. The positioning device 54 can, for example, displace the gripping device 52 by means of a drive, in particular an electric drive and/or a pneumatic drive and/or a hydraulic drive.

After the gripping device 52 and the inlay 46 have been displaced to the target position, the gripping elements are moved apart and release the inlay 46.

The inlay 46 is preferably released after the inlay has been connected to the packaging material 22, advantageously to only one layer of the packaging material 22, for example by the connecting device 42 described.

The gripping device 52 is displaced in the opposite direction to the starting position in order to grip and/or pick up a further inlay 46.

As an alternative to the insertion device 32 shown, a plurality of gripping devices 52 can be provided. In particular, they can be arranged substantially circularly. The positioning device 54 can also rotate the one or more gripping elements 52 in the same direction and displace them between the starting position and the target position. This is particularly advantageous in order to enable a continuous insertion of inlays 46 to the packaging material 22, so that the packaging material 22 does not have to be stopped.

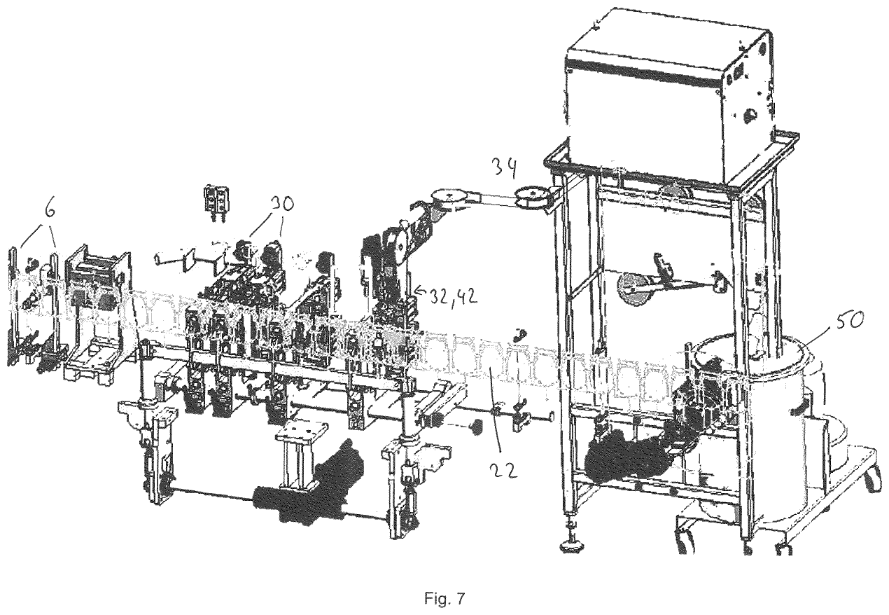

FIG. 7 shows an exemplary packaging machine 1 for manufacturing a packaging container 20 with inlay 46 with the exemplary insertion device 32 and the exemplary supply device 34 of FIG. 2 as well as container forming devices 30 and separating devices 6.

### REFERENCE NUMERAL LIST

1 packaging machine
2 arranging device
4 forming or folding device
6 separating device
8 filling device
10 rotary machine
12 opening device/pocket forming device
14 introduction device
16 direction of transport
18 control device
20 packaging containers
22 packaging material
24 connecting seam
26 fold/pleat
30 container forming device
32 insertion device
34 supply device
36 detection unit
38 separating device
40 closing device
42 connecting device
44 sealing jaw
46 inlay
50 roll/cassette/reel
52 gripping device
54 positioning device

1. A method for manufacturing a packaging container with inlay, comprising the steps of:
arranging a first layer of packaging material and a second layer of packaging material to form a packaging container;
positioning an inlay between the first and second layers of packaging material;
connecting at least a first region of the inlay to the first layer of packaging material;
manufacturing a packaging container by connecting the first and second layers of packaging material such that a filling opening of the packaging container is formed between a second region of the inlay and the second layer of packaging material; and
connecting at least the second region of the inlay to the second layer of packaging material of the filled packaging container.

2. The method according to claim 1, further comprising:
closing the filled packaging container by connecting the first and second layers of packaging material.

3. The method according to claim 1,
wherein the first layer of packaging material is arranged substantially opposite and/or overlapping the second layer of packaging material;
wherein the first region of the inlay is arranged substantially opposite the second region of the inlay;
wherein the filling opening of the packaging container is temporarily formed and closed by connecting the second region of the inlay to the second layer of packaging material; and/or
wherein after connecting the second region of the inlay to the second layer of packaging material, a dispensing opening for dispensing packaging container contents is formed only by the inlay.

4. The method according to claim 1, wherein upon connection of the first region of the inlay to the first layer of packaging material, substantially no connection of the inlay to the second layer of packaging material takes place.

5. The method according to claim 1, further comprising:
deforming the packaging container such that the filling opening of the packaging container is opened; and
filling the packaging container with filling material through the filling opening of the packaging container.

6. The method according to claim 1, further comprising:
supplying a plurality of interconnected inlays;
gripping and/or holding an inlay;
separating the gripped and/or held inlay; and/or
positioning the separated inlay between the first and second layers of packaging material.

7. The method according to claim 1, wherein positioning the inlay between the first and second layers takes place by:
a substantially rotational displacement of the inlay, preferably about an axis of rotation aligned orthogonally to a direction of transport of the first and second layers of packaging material;
a substantially translational displacement of the inlay, preferably at least partially parallel and/orthogonal to a direction of transport of the first and second layers of packaging material; and/or
a displacement of the inlay such that the inlay is positioned and/or aligned substantially congruently and/or parallel to a direction of transport of the first and second layers of packaging material.

8. An insertion device for inserting and/or positioning an inlay between a first and a second layer of packaging material, the insertion device being configured to:
accommodate an inlay at least temporarily;
position between a first and a second layer of packaging material; and
release the inlay.

9. The insertion device according to claim 8, further comprising:
a gripping device for gripping and/or holding an inlay;
a separating device for separating the gripped and/or held inlay from the plurality of interconnected inlays; and
a positioning device for positioning the separated inlay between the first and second layers of packaging material.

10. The insertion device according to claim 9, wherein the positioning device is configured to:
displace the inlay substantially rotationally, preferably about an axis of rotation aligned orthogonally to a direction of transport of the first and second layers of packaging material;
displace the inlay substantially translationally, preferably at least partially parallel and/or congruent to a direction of transport of the first and second layers of packaging material;
displace the inlay such that the inlay is positioned and/or aligned substantially congruently and/or parallel to a direction of transport of the first and second layers of packaging material.

11. A packaging machine for manufacturing a packaging container with inlay, comprising:
an arranging device for arranging a first layer of packaging material and a second layer of packaging material to form a packaging container;
an insertion device for inserting and/or positioning an inlay between a first and a second layer of packaging material;
a connecting device for connecting a first region of the inlay to the first layer of packaging material; and
a closing device for connecting a second region of the inlay to the second layer of packaging material.

12. The packaging machine according to claim 11,
wherein the connecting device is configured to connect only the first region of the inlay to the first layer of packaging material; and/or
wherein the closing device is configured to connect only the second region of the inlay to the second layer of packaging material and to close the packaging container by connecting the first and second layers of the packaging material.

13. The packaging machine according to claim 11, wherein:
the inlay has one or more dispensing openings,
the inlay is configured to enable dosing and/or controlled dispensing of the contents of the packaging container; and/or
the inlay comprises a valve and/or a membrane and/or a grid and/or a braiding and/or a spout; and/or
the inlay comprises a first element, which is substantially elastically deformable and resilient, and a second element, which is substantially elastically deformable and/or stretchable and/or foldable and has one or more dispensing openings.

14. The packaging machine according to claim 11, further comprising:
a supply device for supplying a plurality of interconnected inlays to the insertion device; and/or
a detection device for detecting the presence and/or the type and/or the alignment of an inlay supplied to the insertion device.

15. The packaging machine according to claim 11, wherein the insertion device is configured to:
accommodate an inlay at least temporarily;
position between a first and a second layer of packaging material; and
release the inlay.

16. The packaging machine according to claim 11, wherein the insertion device further comprises:
a gripping device for gripping and/or holding an inlay;
a separating device for separating the gripped and/or held inlay from the plurality of interconnected inlays; and
a positioning device for positioning the separated inlay between the first and second layers of packaging material.

17. The packaging machine according to claim 16, wherein the positioning device is configured to:
displace the inlay substantially rotationally, preferably about an axis of rotation aligned orthogonally to a direction of transport of the first and second layers of packaging material;
displace the inlay substantially translationally, preferably at least partially parallel and/or congruent to a direction of transport of the first and second layers of packaging material;
displace the inlay such that the inlay is positioned and/or aligned substantially congruently and/or parallel to a direction of transport of the first and second layers of packaging material.
